(19) United States
(12) Patent Application Publication
(10) Pub. No.: US 2024/0128639 A1
(43) Pub. Date: Apr. 18, 2024

(54) UNPOWERED TRANSPARENT ANTENNA

(71) Applicants: LAT CO., LTD., Osan-Si (KR); Kreemo Inc., Seoul (KR)

(72) Inventors: Heung Hwan KIM, Yongin-si (KR); Geun-taek LIM, Suwon-si (KR); In Kyung HONG, Seoul (KR); John Joonho PARK, Seongnam-si (KR)

(73) Assignees: LAT CO., LTD., Osan-Si (KR); Kreemo Inc., Seoul (KR)

(21) Appl. No.: 18/171,824

(22) Filed: Feb. 21, 2023

(30) Foreign Application Priority Data
Oct. 12, 2022 (KR) 10-2022-0130677

(51) Int. Cl. H01Q 1/38; H01Q 1/36; H01Q 3/44

(52) U.S. Cl. CPC H01Q 1/38; H01Q 1/364; H01Q 3/44

(57) ABSTRACT

Discloses is an unpowered transparent antenna that can be installed to reduce or remove a radio wave shadow area such as an interior even without power. In order to achieve the objectives, an unpowered transparent antenna includes: a first conductive layer having a mesh structure; and a second conductive layer having a mesh structure and positioned on the bottom of the first conductive layer, in which an aperture ratio of the first and second conductive layers is 50% or more.

### BACKGROUND OF THE INVENTION

### Field of the Invention

The present disclosure relates to an unpowered transparent antenna and, in more detail, an unpowered transparent antenna that transmits and receives radio waves (signals) even without power.

### Description of the Related Art

In recent years, the use of various wireless communication devices has increased due to the development of wireless communication technologies, but in general, in dense areas such as indoors or buildings, radio wave shadow areas are formed in which radio wave reception strength is weakened due to radio wave loss. As a result, the signal strength of the radio wave is weakened indoors or underground, causing a problem in that the radio reception rate of the wireless communication device is lowered.

In order to compensate for this propagation loss, a high-gain phased array antenna is installed in the base station. In this way, when the phased array antenna is installed in the base station, there is a problem in that the maximum gain of the antenna is saturated due to an increase in insertion loss of a feeding network

In addition, the high-gain phased array antenna may be mounted on the wireless communication device. In this case, since an antenna installation space must be secured, there is a problem in that it is difficult to miniaturize the wireless communication device.

Therefore, a separate wireless repeater (active relay repeater) is installed in the room where the reception strength is relatively low. In this case, it is inconvenient to separately prepare an indoor space for installing the wireless repeater. In addition, since a power is always applied to the wireless repeater, there is a problem in that the amount of electricity is increased.

On the other hand, an antenna that is close to transparent when viewed with the naked eye by transferring or attaching a conductive layer having a high aperture ratio on a transparent substrate has been developed. As an example of such a transparent antenna, a transparent antenna using a mesh structure of Korean Patent Registration No. 10-2166319 (hereinafter referred to as ‘Patent Literature’) is disclosed.

In the Patent Literature, the transparent antenna comprises a transparent layer made of a transparent or translucent material; and a mesh structure provided on the transparent layer while forming a mesh structure. In the mesh structure, the aperture ratio of the mesh is 80% or more and the surface of the mesh structure is coated in black. In addition, the mesh structure includes a mesh network of foaming the mesh structure and an adhesive portion provided on the periphery of the mesh network.

The Patent Literature has poor transparency because the surface of the mesh net is coated in black. For this reason, the aperture ratio is formed to be 80% or more in order to secure the transparency of the mesh, and thereby there is a problem in that the radio wave reception performance of the antenna is limited.

In addition, there is a problem that it is difficult to use for the purpose of reducing or eliminating the radio shadow area because it is installed alone indoors and outdoors instead of the wireless repeater.

Therefore, it is required to develop an antenna that can be installed for the purpose of reducing or eliminating the radio shadow area without applying power instead of the wireless repeater.

### PATENT LITERATURE

Patent Literature 1: KR 10-2166319 B1 (Oct. 15, 2020)
Patent Literature 2: KR 10-2021-0081027 A (Jul. 1, 2021)
Patent Literature 3: KR 10-2021-0081028 A1 (Jul. 1, 2021)
Patent Literature 4: KR 10-2041690 B1 (Nov. 27, 2019)

### SUMMARY OF THE INVENTION

The present disclosure has been made in an effort to solve the problems of transparent antennas in the related art, and an objective of the present disclosure is to provide an unpowered transparent antenna that can be installed to reduce and remove a radio wave shadow area such as an interior even without power.

According to an aspect of the invention to achieve the object described above, there is provided an unpowered transparent antenna including: a first conductive layer having a mesh structure; and a second conductive layer having a mesh structure and positioned on the bottom of the first conductive layer, wherein the first and second conductive layers have an aperture ratio of 50% or more.

In addition, the first conductive layer includes a rectangular frame-shaped edge having a predetermined size; a mesh pattern section formed with a predetermined gap inside the edge; and a plurality of bridges connecting the edge and the mesh pattern section.

In addition, the edge and the mesh pattern section are separably formed, the bridges and the edge are integrally famed, the mesh pattern section has a plurality of connection grooves that is formed on the outer surface of the mesh pattern section to have a predetermined size and in which first ends of the bridges are inserted, and the first ends of the bridges are inserted in the connection grooves, whereby the edge and the mesh pattern section are connected through the bridges.

In addition, the unpowered transparent antenna further includes a substrate layer made of a transparent material and formed at any one selected from the top of the first conductive layer, between the first conductive layer and the second conductive layer, or the bottom of the second conductive layer.

In addition, the first and second conductive layers are formed such that a thickness (t) of a mesh pattern is larger than a width (w) thereof, or are formed in the ratio of 1:1.

In addition, the first and second conductive layers are made of any one material selected from copper (Cu), nickel (Ni), Ag, aluminum (Al), gold (Au), and platinum (Pt), or an alloy thereof, or any one material selected from graphene, carbon nanotube, carbon nanowire, and Ag paste.

In addition, the first and second conductive layers are manufactured by any one method selected from printing, plating, etching, and laser patterning.

In addition, an impedance value of the first and second conductive layers is adjusted by adjusting capacitance and inductance values, and a reflective angle of radio waves is adjusted by adjusting the impedance value.

In addition, the first and second conductive layers are manufactured into square or rectangular unit cells having predetermined width and length sizes and then a plurality of unit cells are arrayed in a plurality of lines, whereby an array cell having a predetermined size is manufactured.

In addition, the unit cell or the array cell is arrayed in a predetermined pattern such that radio waves are reflected into a specific direction using a radio wave reflection direction of the first and second conductive layers.

In addition, the substrate layer is made of any one material selected from polyimide (PI), polyethylene terephthalate (PET), polymethyl methacrylate (PMMA), and glass.

### BRIEF DESCRIPTION OF THE DRAWINGS

The above and other objects, features and advantages of the present invention will be more apparent from the following detailed description taken in conconfluence with the accompanying drawings, in which:

FIG. 1 is an exploded perspective view showing exemplary first and second conductive layers of an unpowered transparent antenna according to the present disclosure;

FIG. 2 is an exploded perspective view showing the exemplary first conductive layer according to the present disclosure;

FIG. 3 is a plan view showing the exemplary first conductive layer according to the present disclosure;

FIG. 4 is a perspective view showing the exemplary second conductive layer according to the present disclosure;

FIG. 5 is a plan view showing the exemplary second conductive layer according to the present disclosure;

FIGS. 6A and 6B are views showing a first embodiment of an unpowered transparent antenna according to the present disclosure;

FIGS. 7A and 7B are views showing a second embodiment of an unpowered transparent antenna according to the present disclosure;

FIG. 8A is a view showing a third embodiment of an unpowered transparent antenna according to the present disclosure;

FIG. 8B is a view showing a fourth embodiment of an unpowered transparent antenna according to the present disclosure;

FIG. 9 is a view showing an example in which an unpowered transparent antenna according to the present disclosure is an array cell;

FIG. 10 is a view showing area difference values of a mesh pattern section of a first conductive layer according to the present disclosure; and

FIG. 11 is a view showing an example in which phase unit cells are arrayed in accordance with the area values of the mesh pattern section according to FIG. 10.

### REFERENCE SIGNS LIST

1: unit cell
2: array cell
10: first conductive layer
11: edge
12: mesh pattern section
12A: connection groove
13: bridge
20: second conductive layer
30: substrate layer
t: thickness of mesh patter
w: width of mesh patter

### DETAILED DESCRIPTION OF THE PREFERRED EMBODIMENT

Hereafter, preferred embodiments of the present disclosure are described in detail with reference to the accompanying drawings.

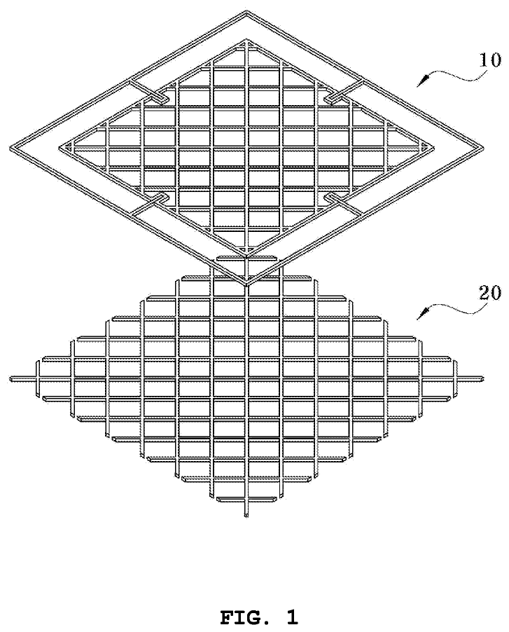

The present disclosure has been made to provide an unpowered transparent antenna that can be installed to reduce and remove a radio wave shadow area such as an interior even without power, and to this end, the present disclosure, as shown in FIG. 1, includes a first conductive layer (10) and a second conductive layer (20).

The first conductive layer (10), which is a component forming a first electrode that reflects radio waves, is formed in a metal mesh type having an aperture ratio of 50% or more.

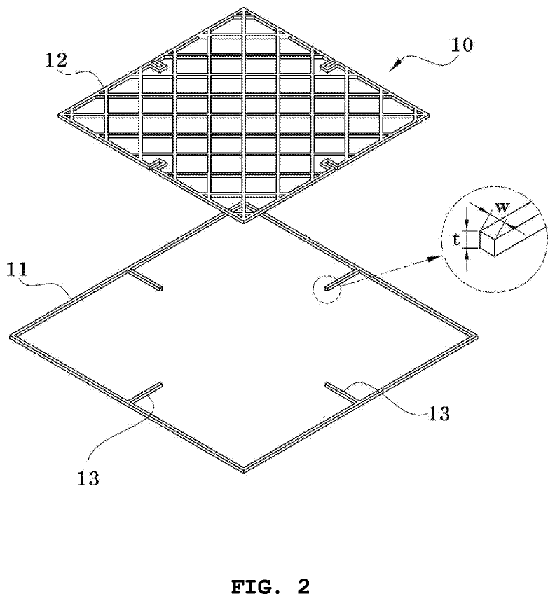

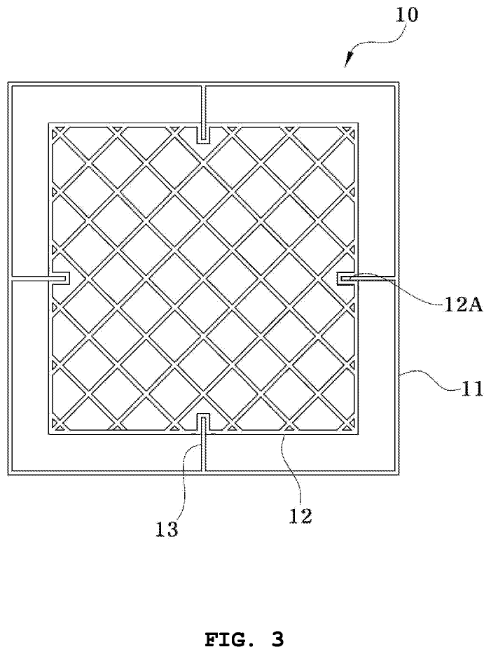

The first conductive layer (10) described above, as shown in FIGS. 2 and 3, includes a square or rectangular frame-shaped edge (11) having a predetermined size, a square or rectangular mesh pattern section (12) having a predetermined size and formed with a predetermined gap inside the edge (11), and a plurality of bridges (13) connecting the edge (11) and the mesh pattern section (12).

The edge (11) and the mesh pattern section (12) may be separably formed, as shown in FIG. 2, and then combined with each other through the bridges (13), and in this case, a plurality of connection grooves (12A) having a predetermined size in which first ends of the bridges (13) are inserted may be formed along the circumference of the mesh pattern section 12.

First ends of the bridges (13) may be integrally formed with the edge (11) and second ends thereof may be fitted in the connection grooves (12A) such that the edge (11) and the mesh pattern section (12) are connected to each other through the bridges (13).

Further, the first conductive layer (10) may be formed such that the thickness of a mesh pattern (line thickness of mesh, t) is larger than the width thereof (line width of mesh, w) or may be formed in the ratio of 1:1 of the thickness and the width, and in this case, the thickness (t) of the mesh pattern may be in the range of 10 to 30 μm.

Further, the first conductive layer (10), which is used as an electrode transmitting (reflecting) radio waves, is made of metal having an excellent radio wave transmission ability, for example, any one material selected from copper (Cu), nickel (Ni), Ag, aluminum (Al), gold (Au), and platinum (Pt), or an alloy thereof, or any one material selected from graphene, carbon nanotube, carbon nanowire, and Ag paste.

Further, it is preferable that the first conductive layer (10) is manufactured by any one method selected from printing, plating, etching, and laser patterning that can precisely form a fine mesh pattern.

The second conductive layer (20), which is a component positioned on the bottom of the first conductive layer (10) for ground connection, is a metal mesh having an aperture ratio of 50% or more similar to the first conductive layer (10).

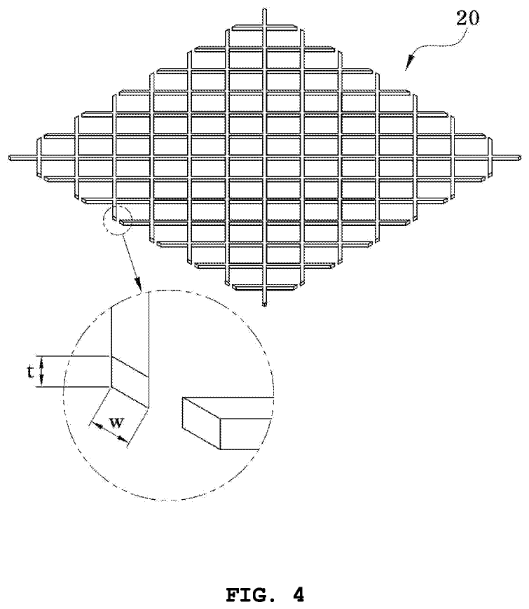

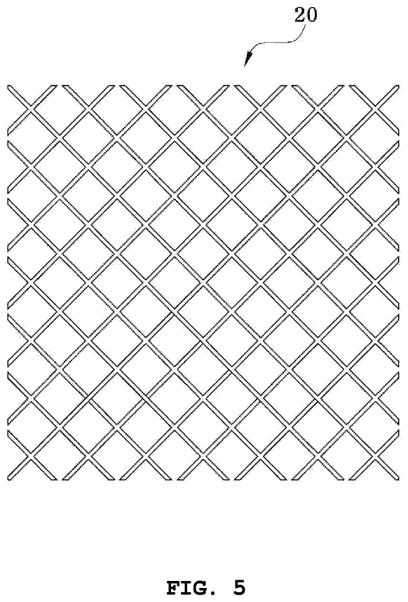

Further, the second conductive layer (20), as shown in FIGS. 4 and 5, is manufactured to have the same width and length sizes as those of the edge (11) of the first conductive layer (10), and may be formed, similar to the first conductive layer (10), such that the thickness of a mesh pattern (line thickness of mesh, t) is larger than the width thereof (line width of mesh, w) or may be formed in the ratio of 1:1 of the thickness and the width, and in this case, the thickness t of the mesh pattern may be in the range of 10 30 μm.

Further, the second conductive layer (20), similar to the first conductive layer (10), may be made of any one material selected from copper (Cu), nickel (Ni), Ag, aluminum (Al), gold (Au), and platinum (Pt), or an alloy thereof, or any one material selected from graphene, carbon nanotube, carbon nanowire, and Ag paste and may be manufactured by any one method selected from printing, plating, etching, and laser patterning.

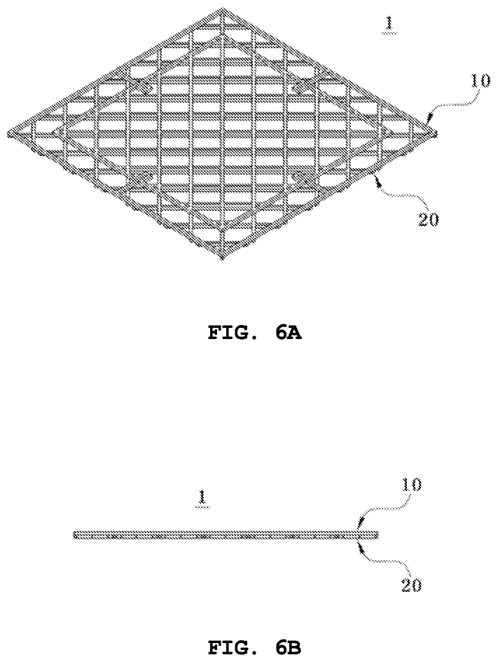

The first and second conductive layers (10 and 20) described above, as shown in FIGS. 6A and 6B, are stacked up and down and integrated and then attached at or around a radio wave shadow area, whereby they can be used as an antenna for reflecting radio waves to the radio wave shadow area.

A substrate layer (30) made of a transparent material and having a predetermined thickness may be further provided so that the first and second conductive layers (10 and 20) can be more easily handled. The substrate layer (30) may be made of any one material selected from polyimide (PI), polyethylene terephthalate (PET), polymethyl methacrylate (PMMA), and glass with a thickness of 300 μm or less to secure transparency.

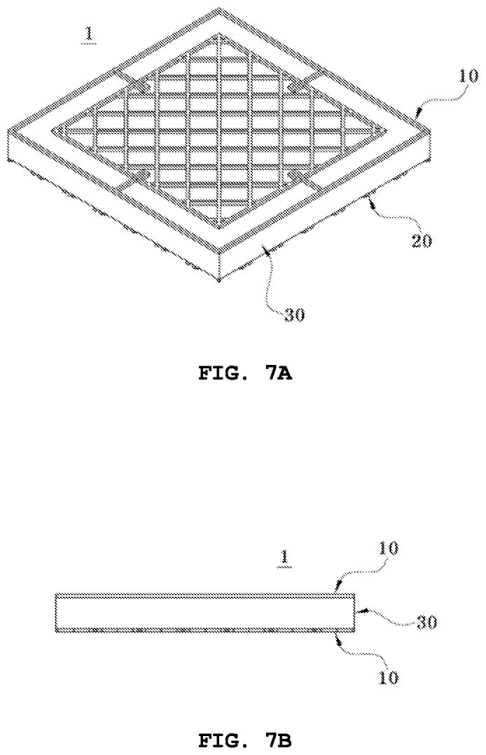

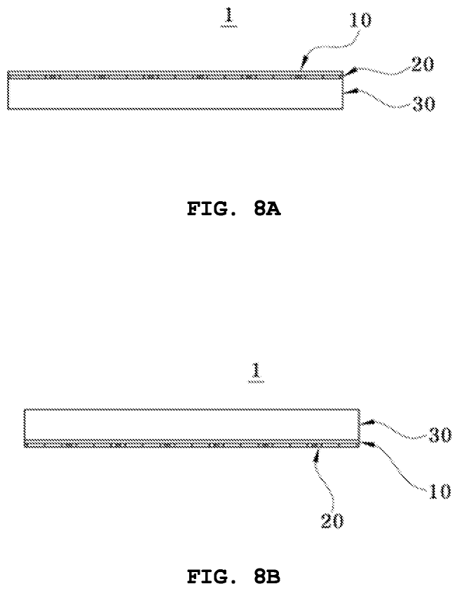

Further, the substrate layer (30), as shown in FIGS. 7A and 7B, may be installed to be positioned between the first and second conductive layers (10 and 20), or, as shown in FIGS. 8A and 8B, may be attached (transcribed or bonded) to the top of the first conductive layer (10) or the bottom of the second conductive layer (20) in a state where the first and second conductive layers (10 and 20) stacked up and down.

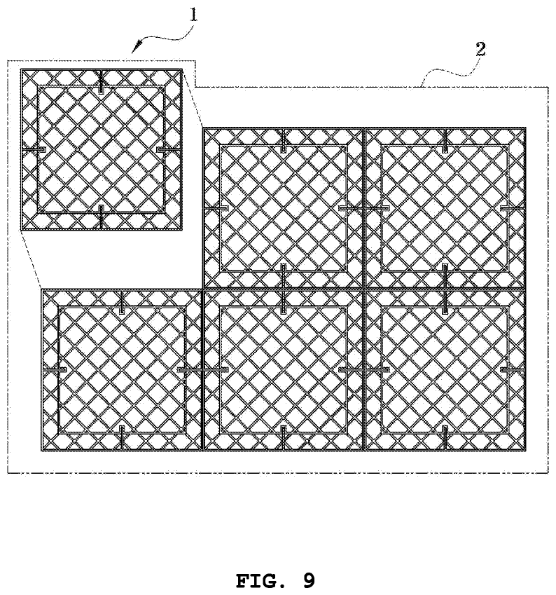

Meanwhile, a plurality of square or rectangular unit cells (1) each of which having the first and second conductive layers (10 and 20) stacked up and down and having predetermined width and length sizes or each of which further including the substrate layer (30) on the first and second conductive layers (10 and 20) is manufactured. A predetermined number of such unit cells (1), as shown in FIG. 9, are arrayed to have a predetermined phase difference, whereby one array cell (2) is manufactured.

In this case, one array cell (2) may be composed of 2 to 12 unit cells (1) and a plurality of such unit cells (2) is disposed to have a predetermined pattern, whereby they are manufactured into a flat transparent antenna having a predetermined size.

Further, the reflective angle of an antenna manufactured by arraying a plurality of array cells (2) may be adjusted so that radio waves (signals) are reflected into a specific direction (to a radio wave shadow area), and to this end, an impedance (resistance) value is adjusted by adjusting capacitance values and inductance between the first and second conductive layers (10 and 20).

When a reflective angle of radio waves is adjusted by adjusting the impedance value of the first and second conductive layers (10 and 20) as described above, radio waves (signals) are reflected into a specific direction in accordance with the reflective angle, whereby radio waves can be guided to a radio wave shadow area or radio waves in a radio wave shadow area can be guided to be uniformly distributed.

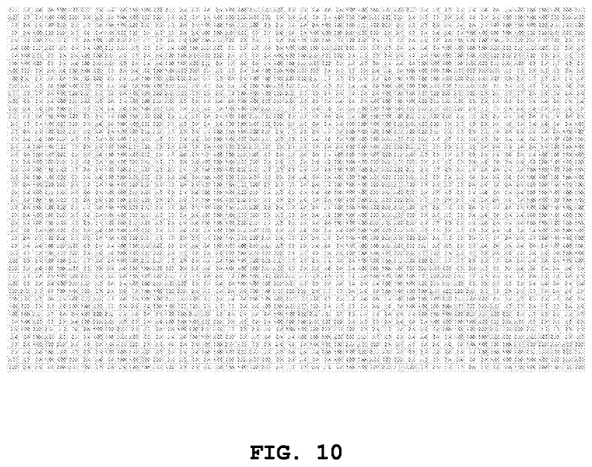

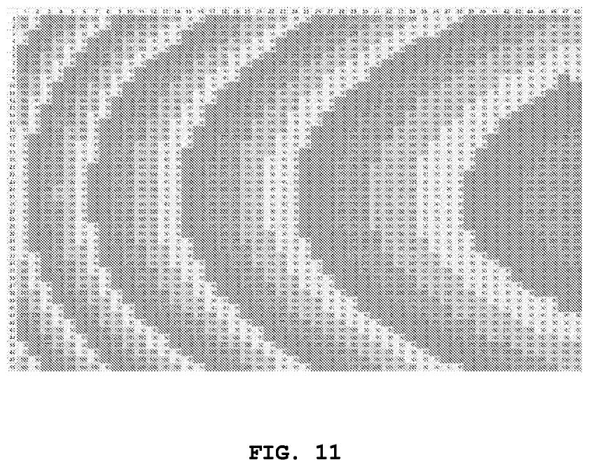

Further, the present disclosure may be configured such that a unit cell (1) or an array cell (2) is disposed to have a certain pattern such that radio waves (signals) are reflected linearly or radially. To this end, an antenna having a certain pattern in a specific direction may be configured, as shown in FIGS. 10 and 11, by making the area of the mesh pattern section (12) of the first conductive layer (10) to be different for the unit cell (1) or the array cell (2).

As described above, according to the present disclosure, first and second conductive layers are provided, whereby radio waves can be reflected into a specific direction. Therefore, radio waves are guided to a shadow area by attaching an antenna at or around a radio wave shadow area, whereby it is possible to reduce or remove a radio wave shadow area.

Further, it is possible to guide radio waves into a specific direction even without applying separate power, and accordingly, it is possible to easily attach and use the antenna at various outdoor places where power is difficult to supply.

According to the present disclosure, first and second conductive layers are provided, whereby radio waves can be reflected into a specific direction. Therefore, radio waves are guided to a shadow area by attaching an antenna at or around a radio wave shadow are, whereby it is possible to reduce or remove a radio wave shadow area.

Further, there is an advantage that it is possible to guide radio waves into a specific direction even without applying separate power, and accordingly, it is possible to easily attach and use the antenna at various outdoor places where power is difficult to supply.

In the above, for the convenience of explanation, the drawings illustrating the preferred embodiments and the configurations shown in the drawings have been described with reference numerals and names. However, as an embodiment according to the present invention, the scope of the invention should not be interpreted as it is limited to the shapes shown in the drawings and the names given. While the present invention has been described with respect to the specific embodiments, it will be apparent to those skilled in the art that various changes and modifications may be made without departing from the spirit and scope of the invention as defined in the following claims.

What is claimed is:

1. An unpowered transparent antenna comprising:
a first conductive layer (10) having a mesh structure; and
a second conductive layer (20) having a mesh structure and positioned on the bottom of the first conductive layer (10),
wherein the first and second conductive layers (10 and 20) have an aperture ratio of 50% or more.

2. The unpowered transparent antenna of claim 1, wherein
the first conductive layer (10) includes:
a rectangular frame-shaped edge (11) having a predetermined size;
a mesh pattern section (12) formed with a predetermined gap inside the edge (11); and
a plurality of bridges (13) connecting the edge (11) and the mesh pattern section (12).

3. The unpowered transparent antenna of claim 2, wherein
the edge (11) and the mesh pattern section (12) are separably formed,
the bridges (13) and the edge (11) are integrally formed,
the mesh pattern section (12) has a plurality of connection grooves (12A) that is formed on the outer surface of the mesh pattern section to have a predetermined size and in which first ends of the bridges (13) are inserted, and
the first ends of the bridges (13) are inserted in the connection grooves (12A), whereby the edge (11) and the mesh pattern section (12) are connected through the bridges (13).

4. The unpowered transparent antenna of claim 1, further comprising
a substrate layer (30) made of a transparent material and foamed at any one selected from the top of the first conductive layer (10), between the first conductive layer (10) and the second conductive layer (20), or the bottom of the second conductive layer (20).

5. The unpowered transparent antenna of claim 1, wherein
the first and second conductive layers (10 and 20) are formed such that a thickness (t) of a mesh pattern is larger than a width (w) thereof, or are formed in the ratio of 1:1.

6. The unpowered transparent antenna of claim 1, wherein
the first and second conductive layers (10 and 20) are made of any one material selected from copper (Cu), nickel (Ni), Ag, aluminum (Al), gold (Au), and platinum (Pt), or an alloy thereof, or any one material selected from graphene, carbon nanotube, carbon nanowire, and Ag paste.

7. The unpowered transparent antenna of claim 1, wherein
the first and second conductive layers (10 and 20) are manufactured by any one method selected from printing, plating, etching, and laser patterning.

8. The unpowered transparent antenna of claim 1, wherein
an impedance value of the first and second conductive layers (10 and 20) is adjusted by adjusting capacitance and inductance values, and a reflective angle of radio waves is adjusted by adjusting the impedance value.

9. The unpowered transparent antenna of claim 1, wherein
the first and second conductive layers (10 and 20) are manufactured into square or rectangular unit cells having predetermined width and length sizes and then a plurality of unit cells are arrayed in a plurality of lines, whereby an array cell having a predetermined size is manufactured.

10. The unpowered transparent antenna of claim 9, wherein
the unit cell or the array cell is arrayed in a predetermined pattern such that radio waves are reflected into a specific direction using a radio wave reflection direction of the first and second conductive layers (10 and 20).

11. The unpowered transparent antenna of claim 4, wherein
the substrate layer (30) is made of any one material selected from polyimide (PI), polyethylene terephthalate (PET), polymethyl methacrylate (PMMA), and glass.

12. The unpowered transparent antenna of claim 2, wherein
the first and second conductive layers (10 and 20) are made of any one material selected from copper (Cu), nickel (Ni), Ag, aluminum (Al), gold (Au), and platinum (Pt), or an alloy thereof, or any one material selected from graphene, carbon nanotube, carbon nanowire, and Ag paste.

13. The unpowered transparent antenna of claim 2, wherein
the first and second conductive layers (10 and 20) are manufactured by any one method selected from printing, plating, etching, and laser patterning.

14. The unpowered transparent antenna of claim 2, wherein
an impedance value of the first and second conductive layers (10 and 20) is adjusted by adjusting capacitance and inductance values, and a reflective angle of radio waves is adjusted by adjusting the impedance value.

15. The unpowered transparent antenna of claim 2, wherein
the first and second conductive layers (10 and 20) are manufactured into square or rectangular unit cells having predetermined width and length sizes and then a plurality of unit cells are arrayed in a plurality of lines, whereby an array cell having a predetermined size is manufactured.

16. The unpowered transparent antenna of claim 4, wherein
the first and second conductive layers (10 and 20) are made of any one material selected from copper (Cu), nickel (Ni), Ag, aluminum (Al), gold (Au), and platinum (Pt), or an alloy thereof, or any one material selected from graphene, carbon nanotube, carbon nanowire, and Ag paste.

17. The unpowered transparent antenna of claim 4, wherein
the first and second conductive layers (10 and 20) are manufactured by any one method selected from printing, plating, etching, and laser patterning.

18. The unpowered transparent antenna of claim 4, wherein
an impedance value of the first and second conductive layers (10 and 20) is adjusted by adjusting capacitance and inductance values, and a reflective angle of radio waves is adjusted by adjusting the impedance value.

19. The unpowered transparent antenna of claim 4, wherein
the first and second conductive layers (10 and 20) are manufactured into square or rectangular unit cells having predetermined width and length sizes and then a plurality of unit cells are arrayed in a plurality of lines, whereby an array cell having a predetermined size is manufactured.
